(19) United States
(12) Patent Application Publication
(10) Pub. No.: US 2008/0183904 A1
(43) Pub. Date: Jul. 31, 2008

(54) Digital signal processor using handshake interfacing and operating method thereof

(75) Inventor: Moon-Gyung Kim, Suwon-si (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 12/010,140

(22) Filed: Jan. 22, 2008

(30) Foreign Application Priority Data
Jan. 25, 2007 (KR) 10-2007-0007946

(51) Int. Cl. G06F 13/20

(52) U.S. Cl. 710/6

(57) ABSTRACT

Provided are a digital signal processor controlled according to handshake interfacing and a method of operating the digital signal processor. The method of operating the digital signal processor may comprise receiving a request signal for executing an application program from an external device, reading an address corresponding to the request signal, reading an application program code corresponding to the address from a program memory storing at least one application program code and executing the requested application program according to the read application program code, and outputting an acknowledge signal representing the completion of the execution of the application program to the external device when the execution of the application program has ended.

### PRIORITY STATEMENT

This application claims priority under 35 U.S.C. § 119 to Korean Patent Application No. 2007-0007946, filed on Jan. 25, 2007, in the Korean Intellectual Property Office (KIPO), the entire contents of which are herein incorporated by reference.

### BACKGROUND

1. Field

Example embodiments relate to a digital signal processor that transmits/receives signals to/from external devices using a handshake interfacing method and is operated by the signals, and a method of operating the digital signal processor.

2. Description of Related Art

A digital signal processor processes audio signals and video signals and is used in a variety of technological devices (e.g., cellular phones, video cameras, multimedia systems, and etc).

FIG. 1 is a block diagram of a system including a conventional digital signal processor 10. Referring to FIG. 1, the digital signal processor 10 is operated in connection with a main processor 20 and an interface circuit 30 located between the main processor 20 and the digital signal processor 10. The interface circuit 30 transmits signals to the main processor 20 and the digital signal processor 10.

The main processor 20 provides various control signals to the digital signal processor 10 through the interface circuit 30 in order to control the operation of the digital signal processor 10. The digital signal processor 10 reads at least one application program code stored in a program memory 40 and a data signal stored in a data memory 50 to digitally process the data signal under the control of the main processor 20. Furthermore, the digital signal processor 20 executes an instruction of the read application program code under the control of the main processor 20 and provides a signal corresponding to the execution result to the main processor 20.

However, the conventional digital signal processor loads an operating system from a predetermined or given memory and manages application programs based on the operating system. As such, a clock signal and power are applied to the digital signal processor in an instruction waiting state even when an application program is not executed in the digital signal processor, thereby increasing power consumption. Furthermore, once the application programs are recorded in the memory that stores application program codes, it may be difficult to extend the digital signal processor when other applications are generated.

### SUMMARY

Example embodiments provide a digital signal processor that may require lower power consumption and may be extensible for other applications by using handshake interfacing.

According to example embodiments, a method of operating a digital signal processor executing at least one application program may comprise receiving a request signal for executing an application program from an external device, reading an address corresponding to the request signal, reading an application program code corresponding to the address from a program memory storing at least one application program code and executing the requested application program according to the read application program code, and outputting an acknowledge signal representing the completion of the execution of the application program to the external device when the execution of the application program has ended.

The method may further comprise confirming the resource state of the digital signal processor and outputting an accept signal when the application program is executable after the request signal for executing the application program is input.

The reading of the address may include reading the address corresponding to the received request signal from a register storing addresses corresponding to application program codes stored in the program memory.

The executing of the application program may comprise loading the read address to a DSP core, and executing an instruction corresponding to a program counter among instructions included in the application program code using the address loaded to the DSP core as a program counter.

The application program code may include an instruction for ending the execution of the application program.

The digital signal processor may execute N application programs and the request signal may correspond to one of N handshake signals (where N is an integer greater than 1) for requesting the digital signal processor to execute the N application programs.

The method may further comprise converting the power mode of the digital signal processor to a clock off mode when a request signal is not input for a first period of time after the acknowledge signal is output.

The method may further comprise converting the clock off mode to a power-down mode when the clock off mode is maintained for a second period of time.

In the method of operating a digital signal processor, N (where N is an integer greater than 1) handshake signals for executing different application programs may be received as request signals through an interface with an external device. The N or more application program codes may be recorded in the program memory, and address values corresponding to the request signals may be changed to vary application programs executed in response to the respective request signals.

According to example embodiments, a digital signal processor executing at least one application program may comprise a handshake interface unit transmitting/receiving signals to/from an external device through handshaking interfacing, an address register storing address information corresponding to at least one application program code stored in a program memory and storing address information corresponding to a request signal for executing an application program received through the handshake interface unit and being read from the address register, a DSP core receiving an application program code corresponding to the read address information and executing the requested application program, and a DSP controller controlling internal circuits included in the digital signal processor to execute application programs based on signals input through the handshake interface unit.

The DSP controller may comprise a power mode controller controlling the power mode of the digital signal processor to convert the power mode to a clock off mode when a request signal for executing an application program is not input for a first period of time after the acknowledge signal is output.

The power mode controller may control the power mode of the digital signal processor to convert the power mode to a power-down mode when the clock off mode is maintained for a second period of time.

### BRIEF DESCRIPTION OF THE DRAWINGS

Example embodiments will be more clearly understood from the following detailed description taken in conjunction with the accompanying drawings. FIGS. 1-5 represent non-limiting, example embodiments as described herein.

FIG. 1 is a block diagram of a system including a conventional digital signal processor;

FIG. 2 is a block diagram of a digital signal processor according to example embodiments;

FIG. 3 is a block diagram illustrating the operation of the digital signal processor illustrated in FIG. 2 when executing an application program;

FIG. 4 illustrates application program codes executed in the digital signal processor illustrated in FIG. 2; and

FIG. 5 is a flow chart of a method of operating a digital signal processor according to example embodiments.

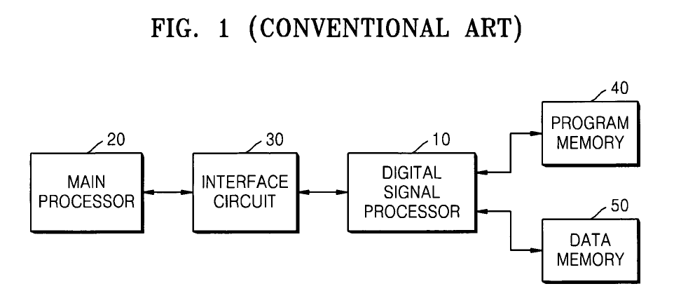

### DETAILED DESCRIPTION OF EXAMPLE EMBODIMENTS

Reference will now be made in detail to example embodiments, examples of which are illustrated in the accompanying drawings. However, example embodiments are not limited to the embodiments illustrated hereinafter, and the embodiments herein are rather introduced to provide easy and complete understanding of the scope and spirit of example embodiments. In the drawings, the thicknesses of layers and regions are exaggerated for clarity.

It will be understood that when an element or layer is referred to as being “on,” “connected to” or “coupled to” another element or layer, it may be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

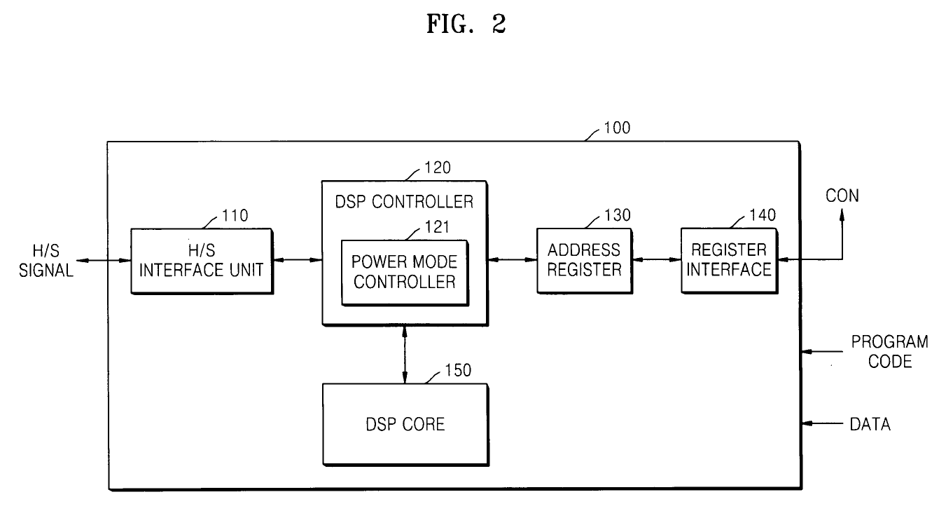

FIG. 2 is a block diagram of a digital signal processor 100 according to example embodiments. Referring to FIG. 2, the digital signal processor 100 may include a handshake interface unit 110, a digital signal processor (DSP) controller 120, an address register 130, a register interface 140, and a DSP core 150.

The handshake interface unit 110 may transmit/receive signals required to operate the digital signal processor 100 to/from an external device according to a handshake interfacing method. A handshake signal H/S SIGNAL transmitted between the external device and the handshake interface unit 110 may include a request signal that requests the digital signal processor 100 to execute a desired, or alternatively, a predetermined or given application program, an accept signal that accepts the request when the digital signal processor executes the application program according to the resource state of the digital signal processor, and an acknowledge signal transmitted to the external device when the execution of the application program has ended.

The DSP controller 120 may control internal circuits included in the digital signal processor 100. Specifically, the DSP controller 120 may judge the resource state of the digital signal processor 100 when a request signal for a specific application program is input from the handshake interface unit 110 and may output the accept signal to the external device through the handshake interface unit 110 when the application program is executable in the digital signal processor 100. Furthermore, the DSP controller 120 may read an address corresponding to the request signal from the address register 130 in order to execute the application program. The read address may be provided to the DSP core 150, and the DSP core 150 may execute the application program according to the address. When the DSP core 150 ends the execution of the application program, the DSP controller 120 may control the acknowledge signal representing the completion of the application program to be output.

The DSP controller 120 may control the internal circuits included in the digital signal processor 100 and it may include a power mode controller 121 for controlling the power mode of the digital signal processor 100. The power mode controller 121 may control the power mode of the digital signal processor and may convert the power mode to a normal mode, a clock off mode, or a power-down mode depending on whether the digital signal processor 100 is being operated or not.

For example, when the acknowledge signal is output as the DSP core 150 ends the execution of the application program corresponding to the request signal, the power mode controller 121 may convert the power mode of the digital signal processor 100 to the clock off mode to block a predetermined or given clock signal from being applied to the DSP core 150 when a request signal for another application program is not input to the digital signal processor for a first period of time. It may be possible to block the clock signal using a switch (not shown), and the power consumption of the digital signal processor 100 may be reduced by controlling the power mode of the digital signal processor 100.

When the clock off mode is maintained for a second period of time after the power mode of the digital signal processor 100 has been converted to the clock off mode, the power mode controller 121 may change the clock off mode to the power-down mode in which power may be applied to only the handshake interface unit 110 and the DSP controller 120 related to handshake interfacing. As such, power provided to the DSP core 150 and other internal circuits may be blocked. Accordingly, the power consumption of the digital signal processor 100 may be further reduced.

A program memory (not shown) storing at least one application program code that will be executed in the digital signal processor 100 may be included in the digital signal processor 100 or externally connected to the digital processor 100. When the program memory stores a plurality of application program codes, the address register 130 may store addresses corresponding to the plurality of application program codes. The number of application programs processed in the digital signal processor 100 may be limited. When N (where N is an integer greater than 1) application programs are processed in the digital signal processor 100, N addresses may be stored in the address register 130. The address, from among the N addresses stored in the address register 130, corresponding to a request signal that requests the digital signal processor 100 to execute an application signal received through the handshake interface unit 130 may be read.

The register interface 140 may transmit signals between the address register 130 and an external device such that the address register 130 is externally controlled. For example, a desired, or alternatively, a predetermined or given control signal CON may be provided to the address register 130 through the register interface 140 to change address values stored in the address register 130.

When the digital signal processor 100 receives N handshake signals (e.g., N request signals) for executing different application programs through the handshake interface unit 110 and the program memory stores at least N application program codes, the application programs executed in response to the request signals may be varied by changing the address values stored in the address register 130 using the control signal CON. Thus, when a variety of application program codes are stored in the program memory and the address values stored in the address register 130 are varied according to applications of the digital signal processor 100, the extensibility of the digital signal processor 100 may be improved.

The DSP core 150 may execute a requested application program using application program codes stored in the program memory and data stored in a data memory. The DSP controller 120 may load an address read from the address register 130 and the DSP core 150 may receive the address and use it as a program counter. For example, the address may be a start address of a corresponding application program. The DSP core 150 may read instructions corresponding to program counters starting at the start address and may execute the instructions to carry out the application program.

Application program codes may include instructions for ending the execution of application programs corresponding to the application program codes. When an instruction for ending an application program corresponding to a received request signal is executed while the DSP core 150 executes the application program, the application program may be ended and information about the completion of the application program may be provided to the DSP controller 120. The DSP controller 120 may control the acknowledge signal to be output to an external device through the handshake interface unit 110 using the information.

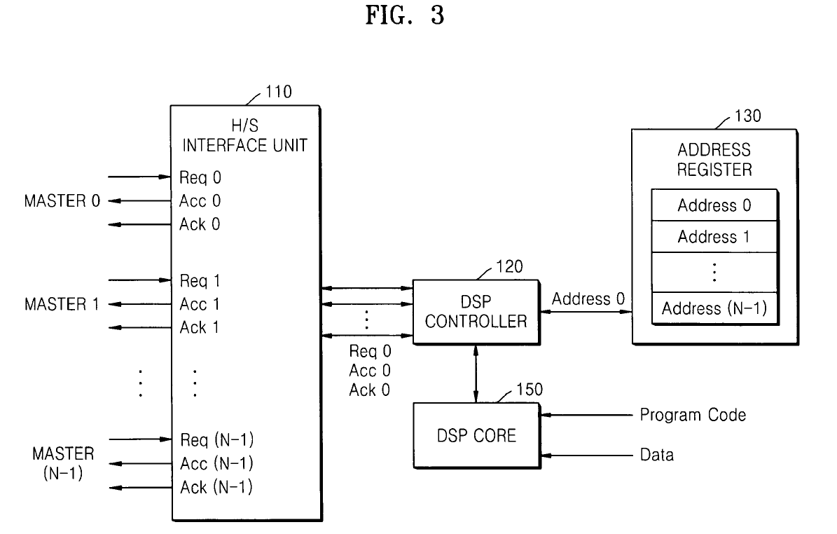

The detailed operation of the digital signal processor 100 described above will now be explained with reference to FIG. 3. FIG. 3 is a block diagram illustrating the operation of the digital signal processor illustrated in FIG. 2 when executing an application program. FIG. 3 illustrates the handshake interface unit 110, the DSP controller 120, the address register 130, and the DSP core 150 of the digital signal processor.

The handshake interface unit 110 of the digital signal processor 100 may be electrically connected to an external master providing a handshake signal. The master may generate the handshake signal based on a signal generated by an input key operation or by an interrupt.

To allow the digital signal processor 100 to execute N application programs according to applications thereof, the handshake interface unit 110 may include ports for transmitting and receiving N request signals, N accept signals, and N acknowledge signals. As illustrated in FIG. 3, the handshake interface unit 110 may transmit/receive handshake signals Req0, Acc0, and Ack0 for executing a first application program, and handshake signals Req1, Acc1, and Ack1 through Req(N−1), Acc(N−1), and Ack(N−1) for respectively executing second through Nth application programs to/from external logic. The external logic for transmitting/receiving the handshake signals Req0, Acc0, and Ack0 may be referred to as master 0.

The handshake interface unit 110 may be electrically connected to the DSP controller 120 through a plurality of lines. The request signals Req may accept signals Acc and acknowledge signal Ack may be transmitted between the handshake interface unit 110 and the DSP controller 120 through the plurality of lines. Information (not shown) regarding which application programs correspond to the transmitted signals may be transferred through the lines.

When the master 0 provides the request signal Req0 to request the digital signal processor 100 to execute the first application program, the DSP controller 120 may receive the request signal Req0 through the handshake interface unit 110. Then, the DSP controller 120 may confirm the resource state of the digital signal processor 100 and may control the accept signal Acc0 to be output through the handshake interface unit 110 when the first application is executable in the digital signal processor.

To execute the first application program in response to the request signal Req0, an address Address0 corresponding to the request signal Req0 may be read from the address register 130. The read address Address0 may be provided to the DSP core 150, and the DSP core 150 may read an application program code stored in the program memory (not shown) using the address Address0. The DSP core 150 may execute the first application program using the read application program code and data.

When the address Address0 is loaded to the DSP core 150, the DSP core 150 may use the loaded address Address0 as a program counter. For example, the loaded address Address0 may correspond to the start address of the first application program code stored in the program memory. Each application program code may include a plurality of instructions. The DSP core 150 may execute a plurality of instructions included in the first application program code, which respectively corresponds to respective program counters, according to a method of up-counting the program counters.

When the execution of the first application program is completed, the DSP core 150 may provide information indicating the completion of the first application program to the DSP controller 120. The DSP controller 120 may then control the acknowledge signal Ack0 to be output through the handshake interface unit 110 based on the information.

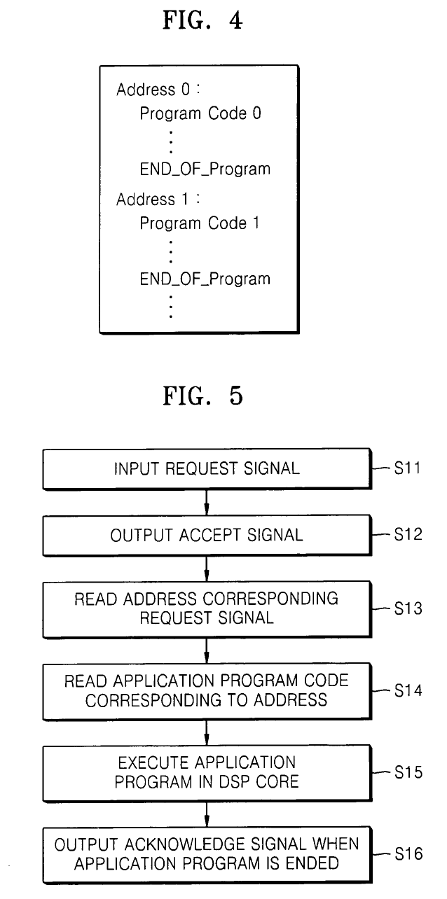

FIG. 4 illustrates application program codes stored in the program memory. As illustrated in FIG. 4, each application program code may include an instruction END_IF_Program for ending the corresponding application program. The DSP core 150 may execute the instruction END_OF_Program and provide the information indicating the end of the corresponding application program to the DSP controller 120.

When another request signal is not input to the digital signal processor 100 for a predetermined or given period of time after the acknowledge signal Ack0 is output, the DSP controller 120 may convert the power mode of the digital signal processor 100 to the clock off mode, as described above. Furthermore, when any request signal is not input to the digital signal processor 100 for a predetermined or given period of time and the clock off mode is maintained after the power mode of the digital signal processor 100 is switched to the clock off mode, the DSP controller 120 may switch the clock off mode to the power-down mode.

FIG. 5 is a flow chart of a method of operating a digital signal processor according to example embodiments.

Referring to FIG. 5, a request signal may be input to the digital signal processor in order to execute a desired, or alternatively, a predetermined or given application program in operation S11. Then, the resource state of the digital signal processor may be confirmed and an accept signal may be output when the application program is executable in the digital signal processor in operation S12.

A program memory storing at least one application program code may be provided to the inside or outside of the digital signal processor, and the digital signal processor may include a register storing an address corresponding to the application program code stored in the program memory. When the request signal is input, an address corresponding to the request signal may be read from the register in operation S13.

A DSP core included in the digital signal processor may receive the read address and read the application program code corresponding to the address from the program memory in operation S14. The DSP core may execute the application program using the application program code and required data in operation S15.

When the DSP core executes an instruction for ending the application program while executing the application program, the DSP core may end the application program and generate information about the completion of the execution of the application program. A DSP controller may output an acknowledge signal representing the end of the requested application program using the information.

As described above, according to the digital signal processor and the method of operating the digital signal processor according to example embodiments, application programs executable in the digital signal processor may be varied so that extensibility of the digital signal processor may be improved. Furthermore, the power mode of the digital signal processor may be changed based on the operating state of the digital signal processor and thus, power consumption of the digital signal processor may be reduced.

The foregoing is illustrative of example embodiments and is not to be construed as limiting thereof. Although example embodiments have been described, those skilled in the art will readily appreciate that many modifications are possible in example embodiments without materially departing from the novel teachings and advantages of example embodiments. Accordingly, all such modifications are intended to be included within the scope of the claims. Therefore, it is to be understood that the foregoing is illustrative of example embodiments and is not to be construed as limited to the specific embodiments disclosed, and that modifications to the disclosed embodiments, as well as other embodiments, are intended to be included within the scope of the appended claims. Example embodiments are defined by the following claims, with equivalents of the claims to be included therein.

What is claimed is:

1. A method of operating a digital signal processor executing at least one application program, comprising:
receiving a request signal for executing an application program from an external device;
reading an address corresponding to the request signal;
reading an application program code corresponding to the address from a program memory storing at least one application program code and executing the requested application program according to the read application program code; and
outputting an acknowledge signal representing the completion of the execution of the application program to the external device when the execution of the application program has ended.

2. The method of claim 1, further comprising:
confirming the resource state of the digital signal processor and outputting an accept signal when the application program is executable after the request signal for executing the application program is input.

3. The method of claim 2, wherein the reading of the address includes reading the address corresponding to the received request signal from a register storing addresses corresponding to application program codes stored in the program memory.

4. The method of claim 3, wherein executing the application program comprises:
loading the read address to a DSP core; and
executing an instruction corresponding to a program counter from among instructions included in the application program code using the address loaded to the DSP core as the program counter.

5. The method of claim 1, wherein the application program code includes an instruction for ending the execution of the application program.

6. The method of claim 1, wherein the digital signal processor executes N application programs (where N is an integer greater than 1) and the request signal corresponds to one of N handshake signals for requesting the digital signal processor to execute the N application programs.

7. The method of claim 1, further comprising:
converting the power mode of the digital signal processor to a clock off mode when the request signal is not input for a first period of time after the acknowledge signal is output.

8. The method of claim 7, further comprising:
converting the clock off mode to a power-down mode when the clock off mode is maintained for a second period of time.

9. The method of claim 1, wherein N (where N is an integer greater than 1) handshake signals for executing different application programs are received as request signals through an interface with an external device, the N or more application program codes being recorded in the program memory and address values corresponding to the request signals being changed to vary application programs executed in response to the respective request signals.

10. A digital signal processor executing at least one application program, comprising:
a handshake interface unit transmitting/receiving signals to/from an external device through handshaking interfacing;
an address register storing address information corresponding to at least one application program code stored in a program memory, and address information corresponding to a request signal for executing an application program, received through the handshake interface unit, and being read from the address register;
a DSP core receiving an application program code corresponding to the read address information and executing the requested application program; and
a DSP controller controlling internal circuits included in the digital signal processor to execute application programs based on signals input through the handshake interface unit.

11. The digital signal processor of claim 10, wherein the address register stores start addresses of N (where N is an integer greater than 1) application program codes stored in the program memory.

12. The digital signal processor of claim 10, wherein the DSP controller receives the request signal for executing an application program, confirms the resource state of the digital signal processor, and controls an accept signal to be output when the application program is executable.

13. The digital signal processor of claim 12, wherein the DSP controller controls an acknowledge signal, representing the completion of the execution of the application program, to be output when the DSP core ends the execution of the application program.

14. The digital signal processor of claim 13, wherein the handshake interface unit transmits/receives N request signals, N accept signals, and N acknowledge signals corresponding to N application programs to/from the external device (where N is an integer greater than 1).

15. The digital signal processor of claim 13, wherein the DSP controller comprises a power mode controller controlling the power mode of the digital signal processor to convert the power mode to a clock off mode when a request signal for executing an application program is not input for a first period of time after the acknowledge signal is output.

16. The digital signal processor of claim 15, wherein the power mode controller controls the power mode of the digital signal processor to convert the power mode to a power-down mode when the clock off mode is maintained for a second period of time.
